(19) United States
(12) Patent Application Publication
(10) Pub. No.: US 2017/0031629 A1
(43) Pub. Date: Feb. 2, 2017

(54) METHOD AND APPARATUS FOR TRANSFERRING BINARY IMAGE INTO MEMORY DEVICE

(71) Applicant: FUJITSU TEN LIMITED, Kobe-shi (JP)

(72) Inventors: Takayoshi NAKAMOTO, Kobe-shi (JP); Shinichi IWAMOTO, Kobe-shi (JP); Mutsuo TANABE, Kobe-shi (JP); Taku YOKAWA, Kobe-shi (JP); Takafumi NARITA, Kobe-shi (JP); Takeshi IGASAKI, Kobe-shi (JP)

(73) Assignee: FUJITSU TEN LIMITED, Kobe-shi (JP)

(21) Appl. No.: 15/210,461

(22) Filed: Jul. 14, 2016

(30) Foreign Application Priority Data
Jul. 27, 2015 (JP) 2015-147813

(51) Int. Cl. G06F 3/06; G06F 12/1009

(52) U.S. Cl. CPC G06F 3/0649; G06F 3/0619; G06F 3/0688; G06F 12/1009; G06F 2212/1036; G06F 2212/2022; G06F 2212/7201; G06F 2212/7211

(57) ABSTRACT

There is provided a method of transferring a binary image into a memory device having a memory controller for performing conversion between physical addresses and logical addresses of storage areas. The binary image is transferred into the memory device such that areas included in the binary image and having no valid data become free areas in storage areas of the memory device, the free areas to which physical addresses and logical addresses are not associated.

### CROSS-REFERENCE TO RELATED APPLICATIONS

This application is based on and claims priority from Japanese Patent Application No. 2015-147813 filed on Jul. 27, 2015.

### TECHNICAL FIELD

The present invention relates to a method and apparatus for transferring a binary image into memory device.

### BACKGROUND

Recently, rewritable memory devices have been widely used in products such as electronic apparatuses and electric apparatuses. For example, in a product manufacturing process, data are written in such memory devices, and those memory devices are assembled in products. Thereafter, when those products are used, data may be written in or read from the memory devices.

In case of memory devices such as flash memories, as the number of times of rewriting increases or as the time when the memory devices are left at high temperature increases, data corruption attributable to leakage of electric charge may occur, resulting in a decrease in data retention period. For this reason, in order to prevent writing areas from being concentrated in a partial area of on such type of a memory device, a wear-leveling function may be performed by a memory controller (see Patent Document 1).

Patent Document 1: Japanese Patent Application Publication No. 2007-323212A

However, the wear-leveling function is performed in a case where the number of times writing has been performed in each of areas of a memory device exceeds a predetermined threshold value, and does not always average the numbers of times of writing on the individual areas. Therefore, in case of such a memory device, as the capacity of free areas decreases, the rate of increase of the number of times of writing increases. For this reason, data corruption may cause a decrease in the usable period of the memory device.

In a product manufacturing process of assembling memory devices, in a case of transferring binary images of a master memory device into other memory devices without correction, thereby writing data into those memory devices, after writing is performed on the entire areas of the memory devices, free areas may not be secured, and the usable periods of the memory devices may decrease.

For this reason, measures to increase the storage capacities of memory devices and reduce the numbers of times data is written in memory devices when products equipped with the memory devices are used have been required.

### SUMMARY

It is therefore an object of the present invention to prolong, for example, the useable periods of memory devices, in a method and apparatus for transferring a binary image into a memory device.

According to an aspect of the embodiments of the present invention, there is provided a method of transferring a binary image into a memory device having a memory controller for performing conversion between physical addresses and logical addresses of storage areas, wherein the binary image is transferred into the memory device such that areas included in the binary image and having no valid data become free areas in storage areas of the memory device, the free areas to which physical addresses and logical addresses are not associated.

The present invention has an effect that it is possible to prolong, for example, the useable periods of memory devices, in a method and apparatus for transferring a binary image into a memory device.

### BRIEF DESCRIPTION OF THE DRAWINGS

In the accompanying drawings:

FIG. 1 is an explanatory view illustrating an example of an image transferring method according to an embodiment

FIG. 2 is an explanatory view relative to a wear-leveling function.

FIGS. 3A and 3B are views illustrating an example of the relation between logical addresses and physical addresses when data is rewritten in a flash memory.

FIGS. 4A and 4B are views illustrating an example of the relation between the maximum number of times of rewriting and the average number of times of rewriting.

FIG. 5 is a view illustrating a first configuration example of an image transferring apparatus.

FIGS. 6A and 6B are views illustrating an example of the configuration of a memory device.

FIG. 7 is a flow chart of an image writing device shown in FIG. 5.

FIG. 8 is a view illustrating a second configuration example of the image transferring apparatus.

FIG. 9 is a view illustrating an image file generating method of an image generating device shown in FIG. 8.

FIG. 10 is a flow chart of the image generating device shown in FIG. 8.

FIG. 11 is a flow chart of an image writing device shown in FIG. 8.

FIG. 12 is a view illustrating a third configuration example of the image transferring apparatus.

FIG. 13 is a view illustrating an image file generating method of an image generating device shown in FIG. 12.

FIG. 14 is a flow chart of the image generating device shown in FIG. 12.

FIG. 15 is a flow chart of an image writing device shown in FIG. 12.

FIG. 16 is a view illustrating a fourth configuration example of the image transferring apparatus.

FIG. 17 is a flow chart of an image generating device shown in FIG. 16.

FIG. 18 is a flow chart of an image writing device shown in FIG. 16.

### DETAILED DESCRIPTION OF THE EMBODIMENTS

Hereinafter, embodiments of a method and apparatus for transferring a binary image into a memory device according to the present invention will be described in detail with reference to the accompanying drawings. However, those embodiments do not limit the present invention. Also, hereinafter, a method of transferring a binary image into a memory device will also be referred to as an image transferring method, and an apparatus for transferring a binary image into a memory device will also be referred to as an image transferring apparatus.

[1. Image Transferring Method]

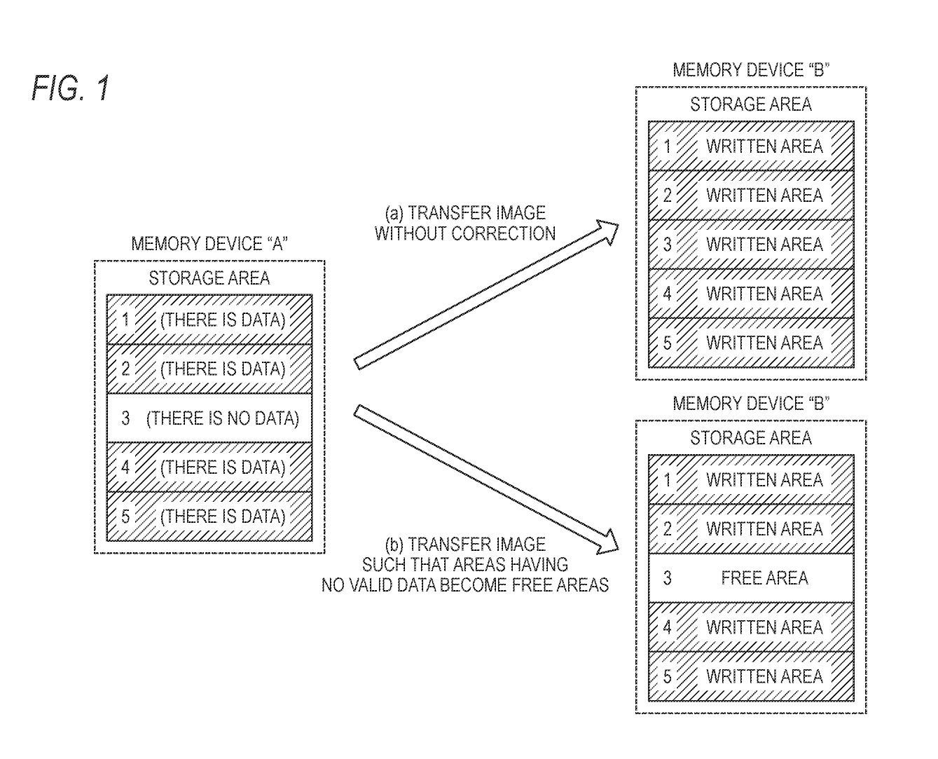

FIG. 1 is an explanatory view illustrating an example of an image transferring method according to an embodiment. In an example shown in FIG. 1, there is shown an image transferring method of transferring a binary image of a memory device “A” into a memory device “B”.

The binary image of the memory device “A” is a binary image file of all data (hereinafter, also referred to as master data) stored in the storage area of the memory device “A”, and the data are arranged in the address order from the initial address to final address of the memory device “A”. Theses addresses are the logical addresses of the memory device “A”. Hereinafter, a case of transferring the binary image of the memory device “A” into the memory device “B” such that data (for example, valid data) corresponding to the logical addresses of the memory device “A” and data (for example, valid data) corresponding to the logical addresses of the memory device “B” become the same as each other will be described.

Also, the memory devices “A” and “B” have the same memory capacity. After the binary image of the memory device “A” is transferred into the memory device “B”, the memory device “B” is mounted in a product such as an electronic apparatus or an electric apparatus. Alternatively, it is possible to mount the memory device “B” in a product, and then transfer the binary image of the memory device “A” into the memory device “B” through a communication unit mounted on the product.

The memory devices “A” and “B” are, for example, rewritable memory devices having a wear-leveling function. For example, the memory devices “A” and “B” are flash memories such as NAND type flash memories.

The memory device “A” is a master memory device which retains transfer target data, and has storage areas 1 to 5, and retains data in the storage areas except for the storage area 3. In a case of transferring the binary image (an image file of binary data of the storage areas 1 to 5) of the memory device “A” into the memory device “B” (see (a) of FIG. 1) without correction, the data is written in the entire area of the memory device “B”.

Therefore, when the transferring of the binary image of the memory device “A” finishes, there may be no free area in the storage areas of the memory device “B”, and the usable period of the memory device “B” may decrease. A free area means a storage area which is one of the storage areas of the memory device “B” and with respect to which physical addresses and logical addresses have not been associated.

An image transferring method according to the embodiment transfers the binary image into the memory device “B” such that each area which does not retain any of the valid data stored in the storage areas of the memory device “A” becomes a free area (see (b) of FIG. 1).

In a case of performing transferring as described above, the data of the area 3 of the memory device “A” having no valid data is not written in any storage area of the memory device “B”. Therefore, as compared to the case of transferring the binary image of the memory device “A” (see (a) of FIG. 1) without correction, it is possible to form a free area (the area 3 of (b) of FIG. 1) in the memory device “B”, and thus it is possible to prolong a period where it is possible to use the memory device “B” (hereinafter, also referred to as a usable period).

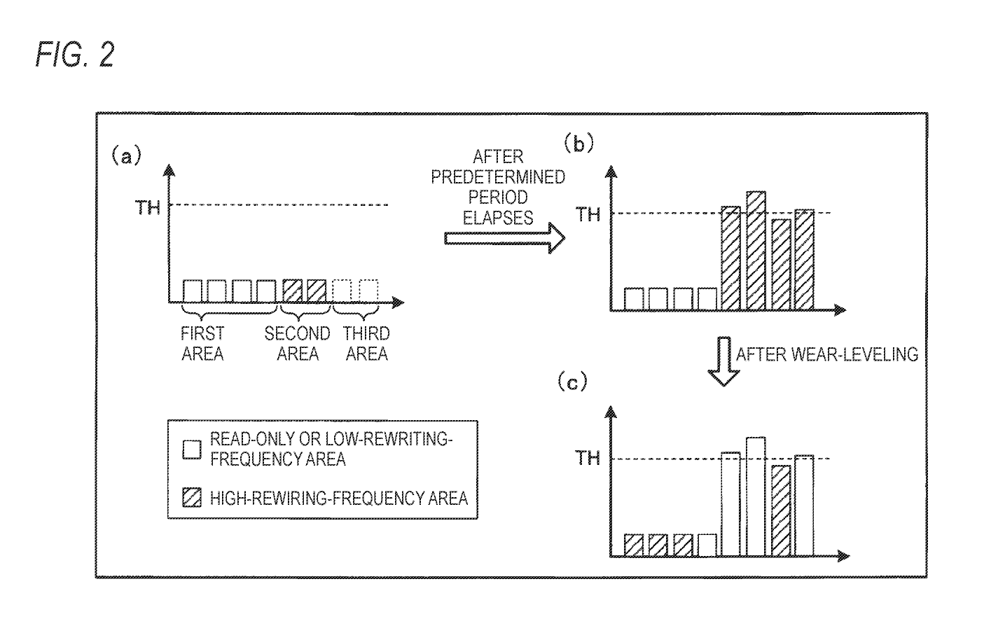

Now, the reason why it is possible to prolong the usable period of the memory device “B” by the image transferring method according to the present embodiment will be described. First, the wear-leveling function of the memory device “B” will be described. FIG. 2 is an explanatory view relative to the wear-leveling function of a flash memory which is an example of the memory device “B”. In FIG. 2, (a) schematically shows the state of the flash memory retaining initial data, and the storage area of the flash memory can be divided into a first area, a second area, and a third area.

The initial data is, for example, data which is retained in the memory device “A” and is written in the memory device “B” in a process of manufacturing products such as electronic apparatuses and electric apparatuses. Also, the first area is a storage area retaining read-only or low-rewriting-frequency data, and the second area is a storage area retaining high-rewiring-frequency data, and the third area is a free area.

After the flash memory retaining the initial data is assembled in a product, if the product is used for a predetermined period or more, the number of times of writing on each of areas corresponding to the second area and the third area shown in (a) of FIG. 2 exceeds a threshold value TH as shown in (b) of FIG. 2. In this case, a memory controller of the flash memory performs the wear-leveling function, thereby rewriting a conversion table for performing conversion between the physical addresses and the logical addresses.

In this way, alignment of the logical addresses to the physical addresses is changed, such that the physical addresses of the second area and the third area exceeding the threshold value TH is replaced by the physical address of the first area, whereby the high-rewiring-frequency storage area and the read-only or low-rewriting-frequency storage area are switched with each other. Therefore, it is possible to suppress the number of times of rewriting on each area. Since the low-rewriting-frequency area and the high-rewiring-frequency area are switched with each other at a predetermined timing by the wear-leveling function as described above, it is possible to average degradation of memory cells.

Now, a difference in the maximum number of times of rewriting attributable to a difference in capacity between free areas will be described. The maximum number of times of rewriting is the maximum of the numbers of times of rewriting on the storage areas of the flash memory, and is the number of times of rewriting on a page unit area or block unit area of the flash memory. Also, writing or reading of data corresponding to the flash memory is performed in units of a page (for example, 2112 bytes), and each block is composed of n-number of pages (for example, n is 64).

In a case of rewriting the flash memory with new data, the new data is not written over data of the same area, and is written in a free area. In this case, assignment of a logical address to the physical address of the original area is canceled, and the corresponding physical address is assigned to the physical address of the area where the data has been newly written. The area with respect to which logical address assignment has been canceled becomes a new free area for next writing. Since different areas sequentially serve as a free area in rotation as described above, rewriting is averagely performed without being concentrated on a specific area.

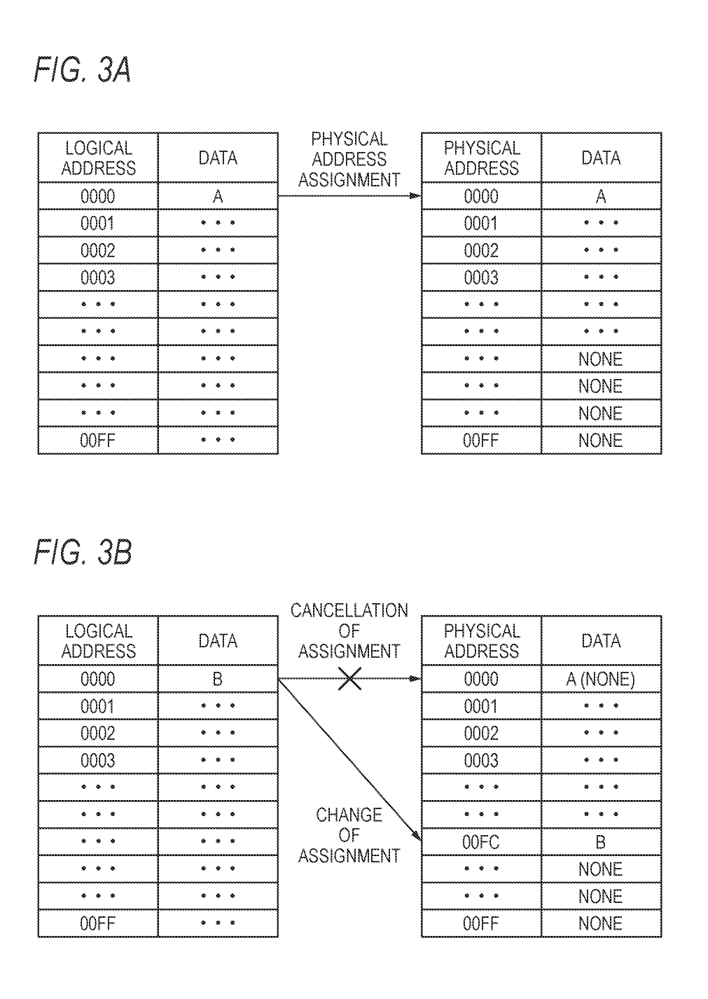

FIGS. 3A and 3B are image views illustrating examples of the relation between the logical addresses and the physical addresses in a case of rewriting the flash memory with data. As show in FIG. 3A, in a case where it is requested to write data “A” in a logical address “0000”, the logical address “0000” is assigned to a physical address “0000”, and the data “A” is written in a storage area having the physical address “0000”. Thereafter, if it is requested to rewrite the data “A” with data “B” with respect to the logical address “0000”, as shown in FIG. 3B, the assignment of the logical address “0000” to the physical address “0000” is canceled, and the logical address “0000” is assigned to a physical address “00FC”, and the data “B” is written in a storage area having the physical address “00FC”. The physical address “0000” with respect to which the logical address assignment has been canceled newly becomes a free area.

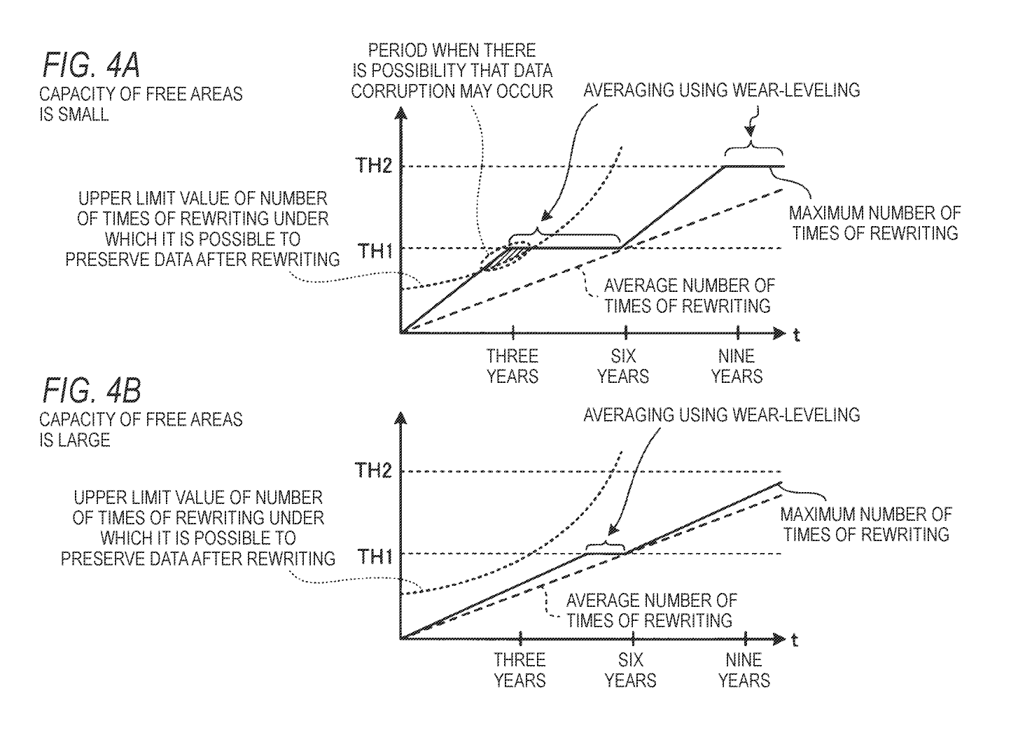

FIGS. 4A and 4B are views illustrating examples of the relation between the maximum number of times of rewriting and the average number of times of rewriting. FIG. 4A shows an example in a case where the capacity of free areas is small when the initial data has been written, and FIG. 4B shows an example in a case where the capacity of free areas is large when the initial data has been written. As shown in FIG. 4B, in the case where the capacity of free areas is large when the initial data has been written, as compared to the case where the capacity of free areas is small, due to rotation of free areas, an interval between when rewriting is perform on one area and when next rewriting is performed on the corresponding area becomes longer, and even if rewriting is performed the same number of times, the number of times of rewriting per one area slowly increases. In other words, since the maximum number of times of rewriting approaches the average number of times of rewriting, it is possible to suppress the number of times of rewriting on each storage area.

Specifically, as shown in FIG. 4A, in the case where the capacity of free areas is small, since the maximum number of times of rewriting rapidly increases, although the average number of times of rewriting is small, in a short time, the number of times of rewriting of a specific area reaches the upper limit value of the number of times of rewriting under which it is possible to preserve data after rewriting. In the area having reached the upper limit, a possibility that data corruption or the like may occur increases, and it becomes impossible to keep the quality of the product. Therefore, it may be impossible to satisfy a lifetime (for example, nine years) presumed for the product. Meanwhile, in the case where the capacity of free areas is large as shown in FIG. 4B, since the maximum number of times of rewriting slowly increases, it is possible to satisfy the presumed product lifetime.

As can be seen from FIGS. 4A and 4B, if the capacity of free areas when the initial data has been written is increased, it is possible to prolong the usable period of the flash memory. Also, in FIGS. 4A and 4B, “TH1” is, for example, ½ of the maximum number of times of rewriting on each page unit area or each block unit area, and “TH2” is, for example, the maximum number of times of rewriting.

Since the image transferring method according to the embodiment transfers the binary image into the memory device “B” such that each area having no valid data becomes a free area, it is possible to increase the capacity of free areas, and it is possible to prolong the usable period of the memory device “B”.

Therefore, for example, as compared to the case of transferring the binary image of the memory device “A” into the memory device “B” without correction, it is possible to suppress the storage capacity of the memory device “B”, and it is possible to reduce the manufacturing cost. Hereinafter, details of the image transferring method and the like will be described with reference to some examples.

[2. First Image Transferring Apparatus and Image Transferring Method]

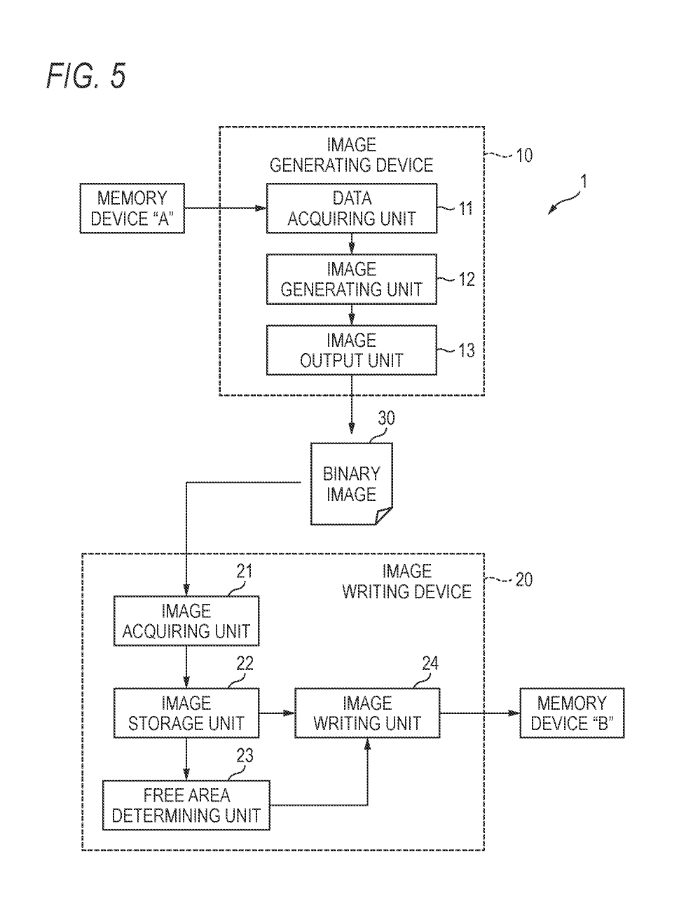

FIG. 5 is a view illustrating a first configuration example of the image transferring apparatus according to the embodiment. An image transferring apparatus 1 shown in FIG. 5 is composed of an image generating device 10 and an image writing device 20.

The image generating device 10 includes a data acquiring unit 11, an image generating unit 12, and an image output unit 13. The data acquiring unit 11 acquires master data which is data stored in the entire storage area of the memory device “A”, by reading out the master data from the memory device “A”.

On the basis of the master data acquired by the data acquiring unit 11, the image generating unit 12 generates a binary image 30. The binary image 30 is one image file which is obtained by binarizing the data stored in the entire storage area and where the data made up of “0” or “1” is arranged in the address order from the initial address to final address of the memory device “A”. The image output unit 13 outputs the binary image 30 generated by the image generating unit 12.

The image writing device 20 includes an image acquiring unit 21 (an example of an acquiring means), an image storage unit 22, a free area determining unit 23 (an example of a determining means), and an image writing unit 24 (an example of a writing means).

The image acquiring unit 21 acquires the binary image 30 generated by the image generating device 10. The image storage unit 22 stores the binary image 30 acquired by the image acquiring unit 21.

The free area determining unit 23 determines areas having no valid data, from the binary image 30 stored in the image storage unit 22. For example, with respect to each of unit areas of the binary image 30 corresponding to pages or blocks of the flash memory, the free area determining unit 23 determines whether there is any valid data in the corresponding unit area. For example, with respect to the unit areas corresponding to the pages or the blocks, the free area determining unit 23 may determine whether there is any area having consecutive 0's or any area having consecutive 1's. In this case, the free area determining unit can determine an area having consecutive 0's or an area having consecutive 1's, as an area having no valid data.

In a case where an area of the binary image 30 stored in the image storage unit 22 has valid data, the image writing unit 24 writes the corresponding data in the memory device “B”. For example, if the free area determining unit 23 determines that a certain area does not have any valid data, the image writing unit 24 performs writing of the binary image 30 without writing the data of the corresponding area in the memory device “B”.

Therefore, data of the addresses of areas having no valid data is not written in the memory device “B”. As a result, as compared to the case of transferring the binary image 30 without correction, it is possible to increase the capacity of free areas, and it is possible to prolong the usable period of the memory device.

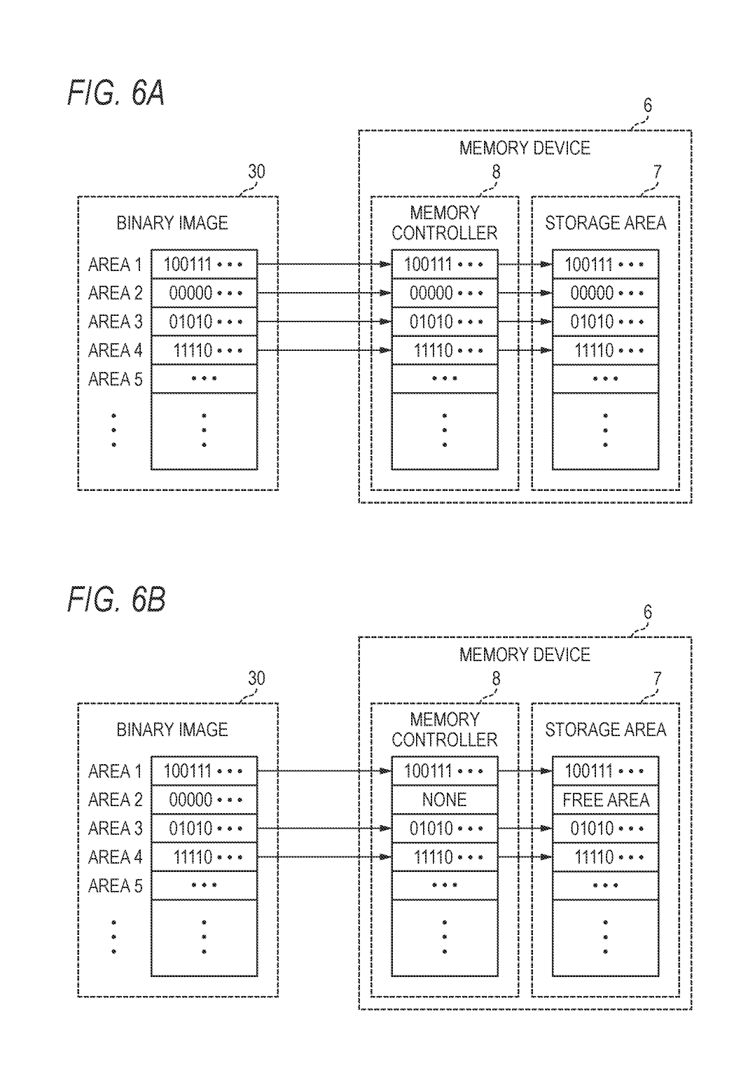

FIGS. 6A and 6B are views illustrating an example of the configuration of a memory device 6 which is an example of the memory device “B”. FIG. 6A shows a case of transferring the binary image 30 into the memory device 6 without correction, and FIG. 6B shows a case of transferring the binary image 30 into the memory device 6 by the image writing device 20.

As shown in FIGS. 6A and 6B, the memory device 6 has a storage area 7 and a memory controller 8. The storage area 7 is an area for storing data, for example, in units of a predetermined number of bits (for example, in units of a page), and a physical address is assigned to each of units of the predetermined number of bits.

The memory controller 8 has a conversion table including physical addresses and logical addresses associated with each other, and in response to access from the outside designating a logical address, the memory controller performs writing of data in a storage area having a physical address corresponding to the logical address, or reading of data from the storage area having the physical address corresponding to the logical address.

Also, the memory controller 8 retains the number of times of rewriting on each of areas corresponding to logical addresses, and performs the above described wear-leveling on the basis of comparison between the number of times of rewriting on each storage area and each of the above described threshold values TH1 and TH2.

For example, the memory controller 8 shuffles data between storage areas having the numbers of times of rewriting equal to or larger than the threshold value TH1, and a storage area having the minimum number of times of rewriting, and changes the conversion table in accordance with the shuffling. In this way, it is possible to change physical addresses while maintaining the correspondence relation between the physical addresses and data.

As show in FIG. 6A, in a case of transferring the binary image 30 into the memory device 6 without correction, the memory controller 8 writes the binary image 30 in the storage area 7 without correction. Therefore, even in a case where the binary image 30 has an area composed of data including, for example, consecutive 0's or 1's, the data of the corresponding area is written in the storage area 7. Therefore, in the storage area 7, an area having the same data size as that of the binary image 30 becomes a writing area.

Meanwhile, with respect to an area of the binary image 30 stored in the image storage unit 22, in a case where the corresponding area has valid data, the image writing device 20 writes the data of the corresponding area in the memory device “B”; whereas in a case where the corresponding area has no valid data, the image writing device does not write the data of the corresponding area in the memory device “B”. Therefore, as shown in FIG. 6B, for example, in case of an area of the binary image 30 having no valid data (for example, the area 2 having consecutive 0's), the data of the corresponding area is not written in the storage area 7.

In this way, it is possible to match an area of the binary image 30 having no valid data with a free area of the memory device “B” with respect to which physical addresses and logical addresses have not been associated. Therefore, as compared to the case of transferring the binary image 30 without correction, it is possible to increase the capacity of free areas, and it is possible to prolong the usable period of the memory device “B”.

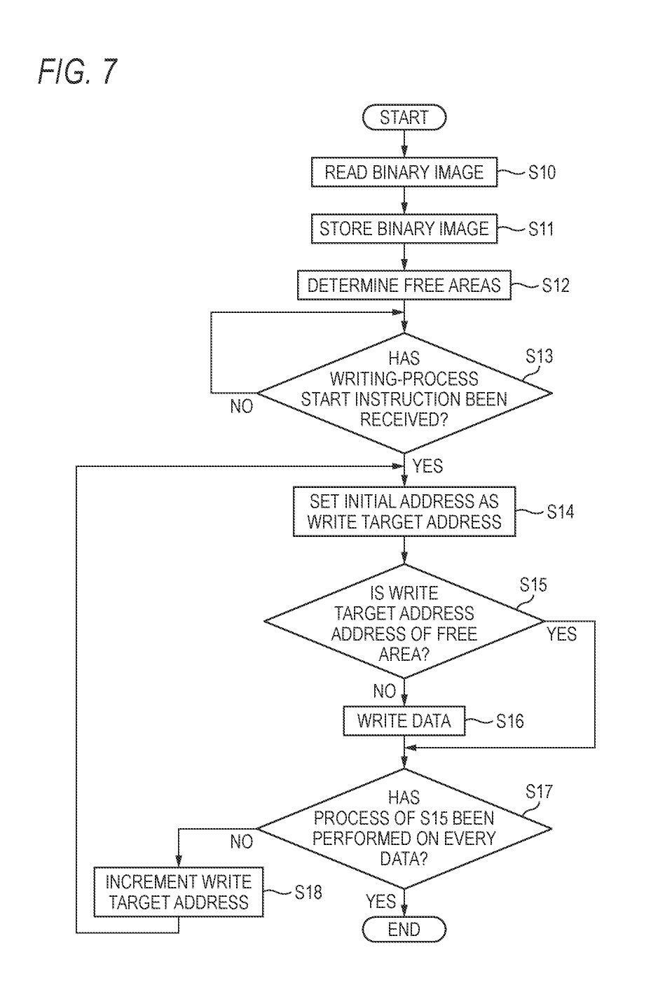

FIG. 7 is a flow chart illustrating the flow of the process of the image writing device 20. As shown in FIG. 7, in STEP S10, the image acquiring unit 21 reads the binary image 30 generated by the image generating device 10. For example, the image acquiring unit 21 can acquire the binary image 30 from the image generating device 10 through a communication line or a recording medium (such as a USB memory or a memory card).

In STEP S11, the image acquiring unit 21 stores the acquired binary image 30 in the image storage unit 22. Subsequently, in STEP S12, the free area determining unit 23 determines free areas of the binary image 30 stored in the image storage unit 22. For example, in a case where an area of the binary image 30 corresponding to a page or a block of the memory device “B” is an area having consecutive 1's or 0's, the free area determining unit 23 determines that the corresponding area is a free area.

Thereafter, in STEP S13, the image writing unit 24 determines whether a writing-process start instruction of a user has been received from an input unit (not shown). In a case of determining that a writing-process start instruction has not been received (“No” in STEP S13), the image writing unit 24 repeatedly performs the process of STEP S13.

Meanwhile, in a case of determining that a writing-process start instruction has been received (“Yes” in STEP S13), in STEP S14, the image writing unit 24 sets the initial address as a write target address. The initial address is the address of a page area or a block area including the initial address of the memory device “B”. Subsequently, in STEP S15, the image writing unit 24 determines whether the write target address is the address of a free area. In the process of STEP S15, for example, in a case where a page or a block corresponding to the write target address is a free area, the image writing unit 24 determines that the write target address is the address of a free area.

In a case of determining that the write target address is not the address of a free area (“No” in STEP S15), in STEP S16, the image writing unit 24 writes the corresponding data in an area of the memory device “B” designated by the write target address.

Meanwhile, in a case of determining that the write target address is the address of a free area (“Yes” in STEP S15), the image writing unit skips the writing process of the STEP S16, and proceeds to the process of STEP S17.

After the process of STEP S16 finishes or in the case of determining that the write target address is the address of a free area (“Yes” in STEP S15), in STEP S17, the image writing unit 24 determines whether the process of STEP S15 has been performed on every data of the binary image 30.

If it is determined that the process of STEP S15 has not been performed on every data (“No” in STEP S17), the image writing unit increments the write target address, and designates the write target address as the address of the next page area or block area, in STEP S18, and proceeds to STEP S14. Meanwhile, if it is determined that the process of STEP S15 has been performed on every data (“Yes” in STEP S17), the image writing unit 24 finishes the process of transferring the binary image 30.

[3. Second Image Transferring Apparatus and Image Transferring Method]

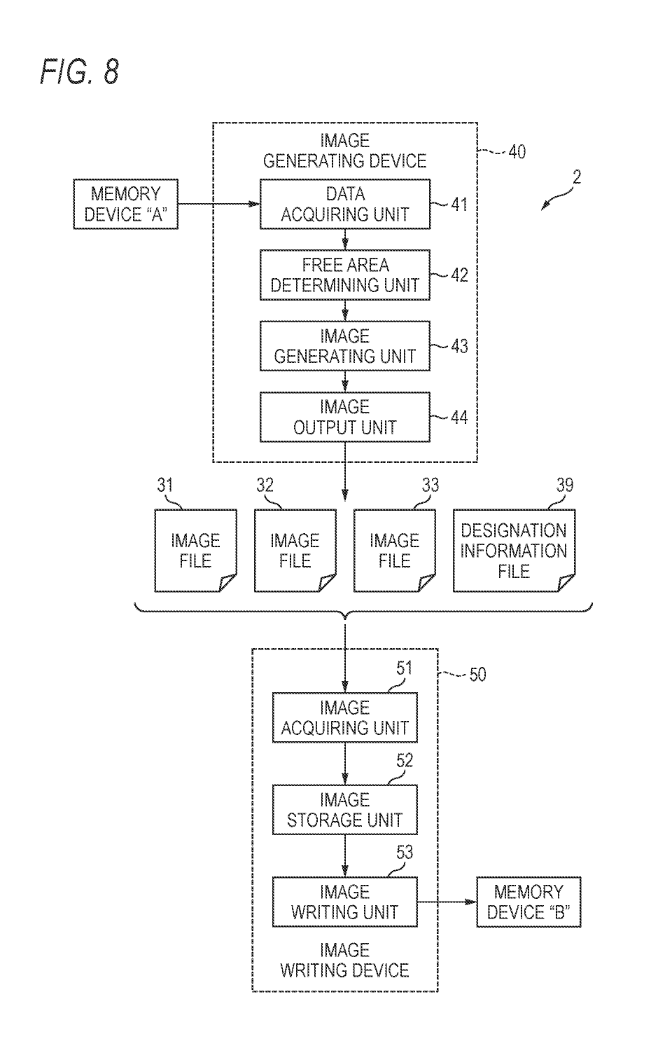

FIG. 8 is a view illustrating a second configuration example of the image transferring apparatus according to the embodiment. An image transferring apparatus 2 shown in FIG. 8 is composed of an image generating device 40 and an image writing device 50. The image generating device 40 includes a data acquiring unit 41, a free area determining unit 42 (an example of the determining means), an image generating unit 43 (an example of a generating means), and an image output unit 44.

The data acquiring unit 41 acquires master data which is the data stored in the entire storage area of the memory device “A”, by reading out the master data from the memory device “A”. After the data acquiring unit 41 acquires the master data, the free area determining unit 42 performs the same process as that of the free area determining unit 23, thereby determining areas included in the master data and having no valid data, as free areas.

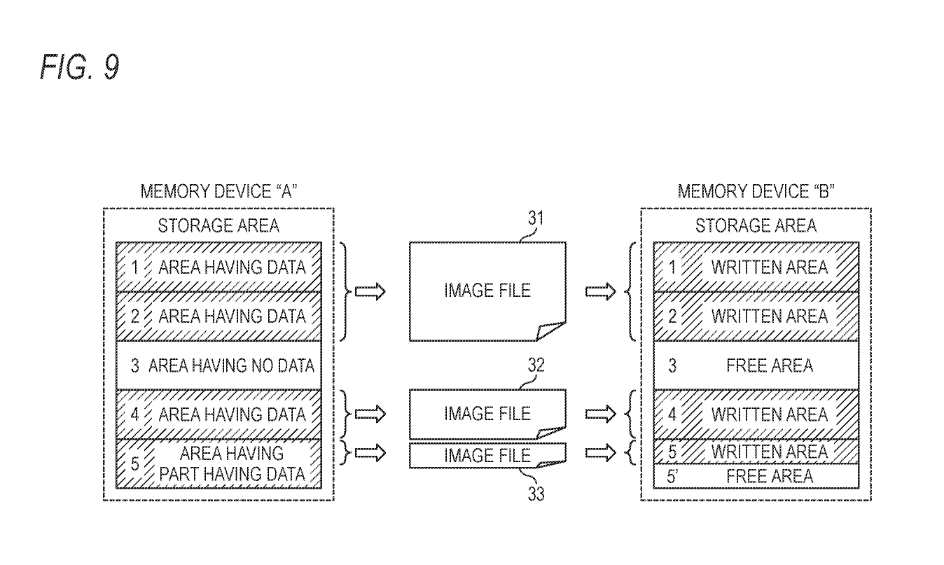

The image generating unit 43 generates a plurality of image files (for example, image files 31 to 33) of areas except for the areas determined as free areas by the free area determining unit 42. For example, the image generating unit 43 generates image files of consecutive areas except for the areas having no valid data. FIG. 9 is a view illustrating the image file generating method of the image generating device 40.

As shown in FIG. 9, in the memory device “A”, each of the areas 1, 2, and 4 has data, and a part of the area 5 has data, and the area 3 has no data. In this case, the image generating unit 43 generates, for example, the image files 31 to 33. Although the following description will be made on the assumption that the image generating unit 43 generates the image files 31 to 33, the number of image files which the image generating unit 43 generates may depend on the locations of areas having no valid data and the number of areas having no valid data.

The image file 31 is a binary image of an area from the initial address of the area 1 (the initial address of the memory device “A”) to the final address of the area 2. The image file 32 is a binary image of an area from the initial address of the area 4 to the final address of the area 4. The image file 33 is a binary image of an area from the initial address of the area 5 to the final address of the part of the area 5 having valid data. Alternatively, the image generating unit 43 can generate a binary image of an area from the initial address of the area 4 to the final address of the part of the area 5 having valid data, as one image file, in place of the image files 32 and 33.

Referring to FIG. 8 again, the image transferring apparatus 2 will be further described. The image output unit 44 outputs the image files 31 to 33 generated by the image generating unit 43, and a file 39 (hereinafter, referred to as the designation information file 39) including designation information for writing the image files 31 to 33 in the memory device “B”. The designation information file 39 is a file of a list including information on the addresses of the image files 31 to 33. For example, the file 39 includes initial addresses (hereinafter, referred to as designation addresses) and write sizes (hereinafter, referred to as designation sizes) for writing the image files 31 to 33 in the memory device “B”.

The designation addresses are set such that the data of the memory device “A” are stored at the same addresses of the memory device “B” as those of the memory device “A”. For example, in the designation information file 39, with respect to the image file 31, the initial address of the memory device “A” is included as a designation address, and the size of data from the initial address of the memory device “A” to the final address of the area 2 is included as a designation size. Instead of providing a designation size, the initial address and final address of a writing area may be designated as designation addresses.

As shown in FIG. 8, the image writing device 50 of the image transferring apparatus 2 includes an image acquiring unit 51, an image storage unit 52, and an image writing unit 53 (an example of the writing means).

The image acquiring unit 51 acquires the image files 31 to 33 and the designation information file 39 generated by the image generating device 40. The image storage unit 52 stores the image files 31 to 33 and the designation information file 39 acquired by the image acquiring unit 51, in association with each other.

The image writing unit 53 writes the image files 31 to 33 stored in the image storage unit 52, in the memory device “B”, on the basis of the designation information file 39. For example, with respect to each of the image files 31 to 33, the image writing unit 53 designates an area starting from a corresponding designation address and having a corresponding data size, and writes the corresponding image file in the designated area of the memory device “B”.

Therefore, it is possible to transfer the binary image of the memory device “A” as shown in FIG. 9 such that the area 3 and a part (an area 5′ shown in FIG. 9) of the area 5 become free areas, and as compared to the case of transferring the binary image 30 without correction, it is possible to increase the capacity of free areas, and it is possible to prolong the usable period of the memory device.

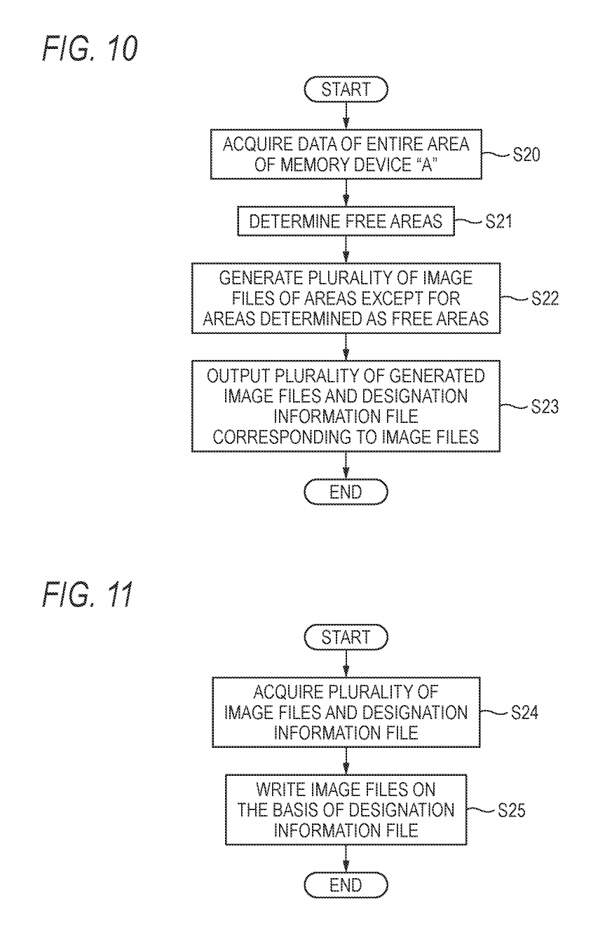

FIG. 10 is a flow chart illustrating the procedure of the process of the image generating device 40. As shown in FIG. 10, in STEP S20, the data acquiring unit 41 acquires the data stored in the entire storage area of the memory device “A”, from the memory device “A”. Subsequently, in STEP S21, the free area determining unit 42 determines areas included in the data acquired by the data acquiring unit 11 and having no valid data.

Next, in STEP S22, the image generating unit 43 generates, for example, a plurality of image files of areas except for the areas determined as free areas by the free area determining unit 42. Subsequently, in STEP S23, the image output unit 44 outputs the image files generated by the image generating unit 43, and a designation information file 39 corresponding to the image files.

FIG. 11 is a flow chart illustrating the flow of the process of the image writing device 50. As shown in FIG. 11, in STEP S24, the image acquiring unit 51 acquires the image files and the designation information file 39 generated by the image generating device 40. Subsequently, in STEP S25, the image writing unit 53 writes the image files stored in the image storage unit 52, at addresses of the memory device “B” designated by the designation information file 39.

[4. Third Image Transferring Apparatus and Image Transferring Method]

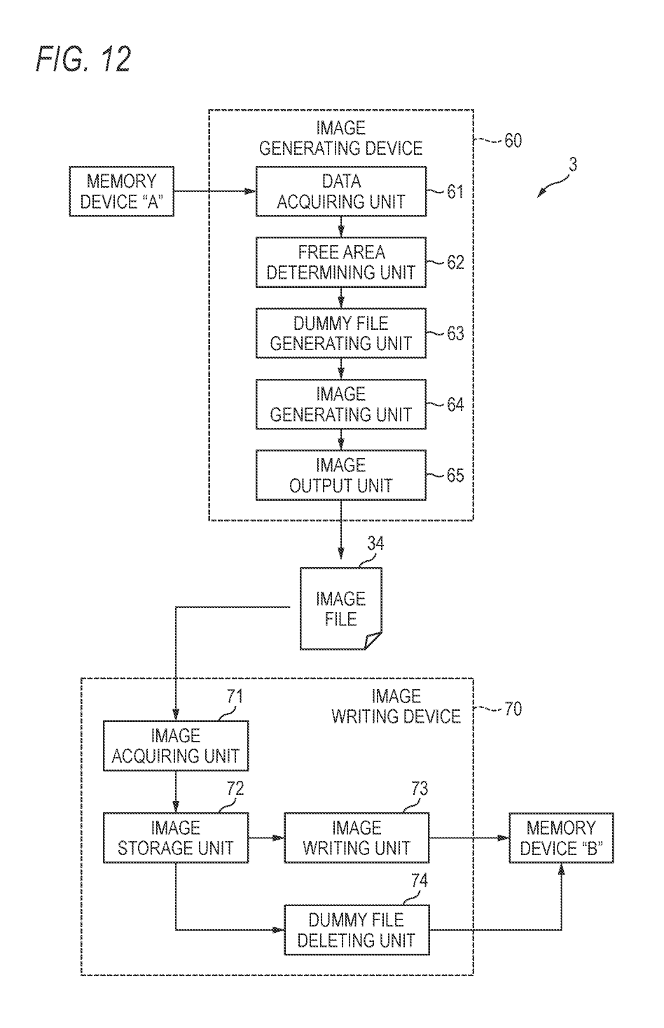

FIG. 12 is a view illustrating a third configuration example of the image transferring apparatus according to the embodiment. An image transferring apparatus 3 shown in FIG. 12 is composed of an image generating device 60 and an image writing device 70. The image generating device 60 includes a data acquiring unit 61, a free area determining unit 62 (an example of the determining means), a dummy file generating unit 63, an image generating unit 64 (an example of the generating means), and an image output unit 65.

The data acquiring unit 61 acquires the master data stored in the entire storage area of the memory device “A”, by reading out the master data from the memory device “A”, similarly to the data acquiring unit 41 described above. After the data acquiring unit 61 acquires the master data, the free area determining unit 62 performs the same process as that of the free area determining unit 42, thereby determining areas included in the master data and having no valid data, as free areas.

The dummy file generating unit 63 generates binary images of the areas determined as free areas by the free area determining unit 62, as deletable dummy image files 35 and 36 (hereinafter, referred to as the dummy files 35 and 36).

The image generating unit 64 replaces the free areas of the master data stored in the entire storage area of the memory device “A”, with the dummy files 35 and 36, thereby generating an image file 34 including the dummy files 35 and 36. In this image file 34, for example, a heard having information on the addresses of the dummy files is included. The image output unit 65 outputs the image file 34 generated by the image generating unit 64.

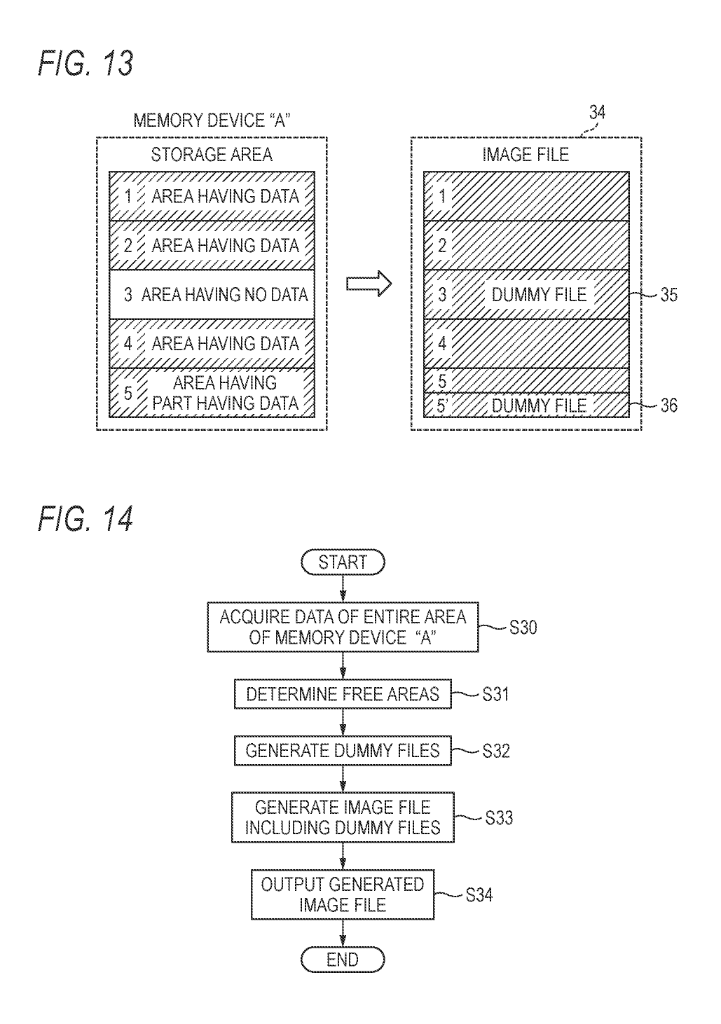

The image file 34 is a file of a binary image having the dummy files in the areas determined as free areas by the free area determining unit 62. FIG. 13 is a view illustrating a method by which the image generating device 60 generates the image file 34. As shown in FIG. 13, the image generating unit 64 can generate the image file 34 having the dummy files 35 and 36 at the area 3 and a part (an area 5′ shown in FIG. 13) of the area 5.

Referring to FIG. 12 again, the image transferring apparatus 3 will be further described. As shown in FIG. 12, the image writing device 70 of the image transferring apparatus 3 includes an image acquiring unit 71, an image storage unit 72, an image writing unit 73 (an example of a writing means), and a dummy file deleting unit 74 (an example of a deleting means).

The image acquiring unit 71 acquires the image file 34 generated by the image generating device 60. The image storage unit 72 stores the image file 34 acquired by the image acquiring unit 71. The image writing unit 73 writes the image file 34 stored in the image storage unit 72, in the memory device “B”.

The dummy file deleting unit 74 deletes the dummy files 35 and 36 from the memory device “B”. In the image file 34, as described above, for example, the header having information on the addresses of the dummy files is included. For example, the dummy file deleting unit 74 determines the addresses of the dummy files 35 and 36 from the header, and deletes the data of areas corresponding to the addresses of the dummy files 35 and 36, from the storage areas of the memory device “B”, thereby deleting the dummy files 35 and 36. As a result, the storage areas of the memory device “B” corresponding to the addresses of the dummy files 35 and 36 are set as free areas.

Also, in a case where the memory controller of the memory means can determine the addresses of the dummy files 35 and 36 by reading the header, the dummy file deleting unit 74 can request the memory device “B” to delete the dummy files 35 and 36. Even in this configuration, it is possible to delete the dummy files 35 and 36.

In this way, it is possible to transfer the binary image of the memory device “A” into the memory device “B” such that the area 3 and the area 5′ (which is a part of the area 5) shown in FIG. 13 become free areas. Therefore, as compared to the case of transferring the binary image 30 without correction, it is possible to increase the capacity of free areas, and it is possible to prolong the usable period of the memory device.

FIG. 14 is a flow chart illustrating the procedure of the process of the image generating device 60. As shown in FIG. 14, in STEP S30, the data acquiring unit 61 acquires the data stored in the entire storage area of the memory device “A”, from the memory device “A”. Subsequently, in STEP S31, the free area determining unit 62 determines free areas included in the data acquired by the data acquiring unit 61 and having no valid data.

Next, in STEP S32, the dummy file generating unit 63 generates binary images of the areas determined as free areas by the free area determining unit 62, as dummy files. Subsequently, in STEP S33, the image generating unit 64 generates the image file 34 including the dummy files, and in STEP S34, the image output unit 65 outputs the image file 34 generated by the image generating unit 64.

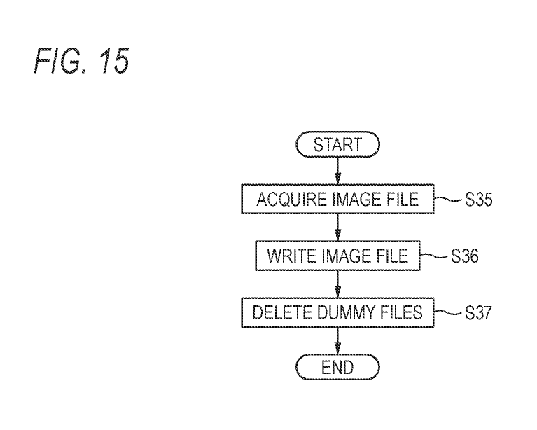

FIG. 15 is a flow chart illustrating the flow of the process of the image writing device 70. As shown in FIG. 15, in STEP S35, the image acquiring unit 71 acquires the image file 34 generated by the image generating device 60. Subsequently, in STEP S36, the image writing unit 73 writes the image file 34 in the memory device “B”. Next, in STEP S37, the dummy file deleting unit 74 deletes the dummy files 35 and 36 from the memory device “B”.

[5. Fourth Image Transferring Apparatus and Image Transferring Method]

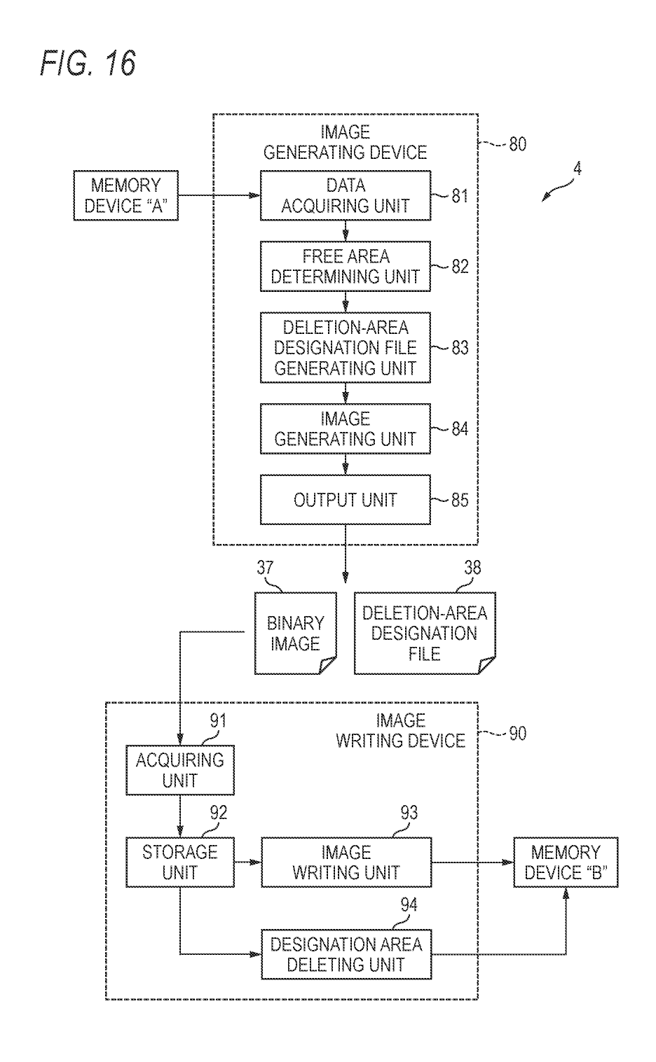

FIG. 16 is a view illustrating a fourth configuration example of the image transferring apparatus according to the embodiment. An image transferring apparatus 4 shown in FIG. 16 is composed of an image generating device 80 and an image writing device 90.

The image generating device 80 includes a data acquiring unit 81, a free area determining unit 82 (an example of the determining means), a deletion-area designation file generating unit 83 (an example of the generating means), an image generating unit 84, and an output unit 85.

The data acquiring unit 81 acquires the master data stored in the entire storage area of the memory device “A”, by reading out the master data from the memory device “A”, similarly to the data acquiring unit 41 described above. After the data acquiring unit 81 acquires the data, the free area determining unit 82 performs the same process as that of the free area determining unit 42, thereby determining areas included in the acquired data and having no valid data, as free areas.

The deletion-area designation file generating unit 83 generates a deletion-area designation file 38 including information such as the addresses of the free areas determined by the free area determining unit 82 (hereinafter, referred to as free area information).

In the deletion-area designation file 38, for example, information specifying the free areas determined by the free area determining unit 82 is included. Also, in the deletion-area designation file 38, for example, the initial addresses and final addresses of the free areas determined by the free area determining unit 82 may be included.

The image generating unit 84 generates a binary image 37 of the entire storage area of the memory device “A” acquired by the data acquiring unit 81. The binary image 37 is the same data as the binary image 30. The output unit 85 outputs the deletion-area designation file 38 generated by the deletion-area designation file generating unit 83, and the binary image 37 generated by the image generating unit 84.

The image writing device 90 includes an acquiring unit 91, a storage unit 92, an image writing unit 93 (an example of the writing means), and a designation area deleting unit 94 (an example of the deleting means).

The acquiring unit 91 acquires the binary image 37 and the deletion-area designation file 38 generated by the image generating device 80. The storage unit 92 stores the binary image 37 and the deletion-area designation file 38 acquired by the acquiring unit 91. The image writing unit 93 writes the binary image 37 stored in the storage unit 92, in the memory device “B”.

The designation area deleting unit 94 deletes data included in the data stored in the memory device “B” and associated with data of areas corresponding to the free area information included in the deletion-area designation file 38, from the memory device “B”. For example, in a case where the free area information includes the initial address and area size of each of the free areas, the designation area deleting unit 94 deletes the data of an area starting from the initial address of a corresponding free area and having a corresponding area size, from the memory device “B”.

Meanwhile, in a case where the free area information includes the initial address and final address of each of the free areas, the designation area deleting unit 94 deletes the data of areas specified by addresses from the initial addresses and final addresses of the individual free areas, from the memory device “B”.

In this way, it is possible to transfer the binary image 37 of the memory device “A” into the memory device “B” such that the areas having no valid data become free areas. Therefore, as compared to the case of transferring the binary image 37 without correction, it is possible to increase the capacity of free areas, and it is possible to prolong the usable period of the memory device.

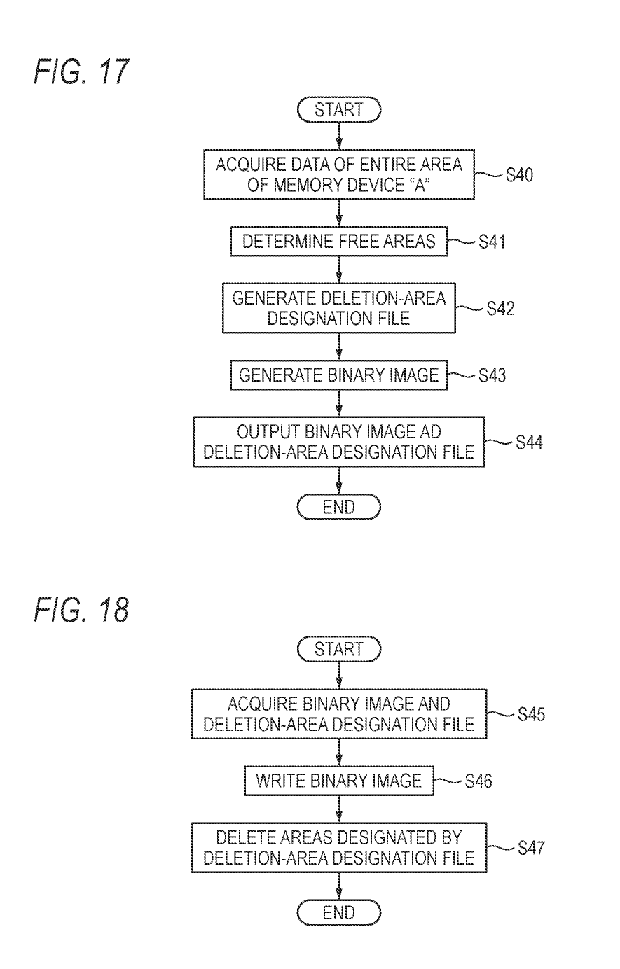

FIG. 17 is a flow chart illustrating the procedure of the process of the image generating device 80. STEPS S40 and S41 shown in FIG. 17 are the processes as STEPS S30 and S31 shown in FIG. 14, and thus will not be described.

As shown in FIG. 17, in STEP S42, the deletion-area designation file generating unit 83 generates the deletion-area designation file 38 including the free area information on the free areas determined by the free area determining unit 82. Subsequently, in STEP S43, the image generating unit 84 generates the binary image 37 of the entire storage area of the memory device “A” acquired by the data acquiring unit 81. Next, in STEP S44, the output unit 85 outputs the binary image 37 generated by the image generating unit 84, and the deletion-area designation file 38 generated by the deletion-area designation file generating unit 83.

FIG. 18 is a flow chart illustrating the flow of the process of the image writing device 90. As shown in FIG. 18, in STEP S45, the acquiring unit 91 acquires the binary image 37 and the deletion-area designation file 38 generated by the image generating device 80. Subsequently, in STEP S46, the image writing unit 93 writes the binary image 37 in the memory device “B”.

In STEP S47, the designation area deleting unit 94 deletes data of areas included in the data stored in the memory device “B” and corresponding to the free area information included in the deletion-area designation file 38, from the memory device “B”.

After the binary image 30 of the memory device “A” is transferred into the memory device “B” by any one of the image transferring apparatuses 1 to 4 according to the embodiment and a corresponding image transferring method, the memory device “B” is assembled in, for example, a device for a vehicle, such as a navigation device, an audio/video device, an information device, or an engine control device. In such a device, a micro computer is mounted, and the memory device “B” is used as a memory for storing programs and data for driving the micro computer.

For example, in case of a navigation device, in the memory device “B”, a program for making the micro computer perform a navigation function (hereinafter, also referred to as a navigation program), data such as maps and facility information (hereinafter, also referred to as map data), and parameters such as time, location, and travel distance are stored.

If the navigation program and the map data are written once, they are not rewritten, or are rewritten if the navigation program and the map data are updated. Therefore, among the program, the data, and the parameters, the navigation program and the map data are data having relatively low rewriting frequencies.

Meanwhile, the parameters such as time, location, and travel distance are rewritten at regular intervals or are sequentially rewritten at predetermined timings while the navigation device is used, and thus are data having relatively high rewriting frequencies. For example, in some cases such as a case where occupants leave the navigation device, even if the navigation device is powered off, information such as current location and destination setting information should be preserved. For this reason, for example, at the timing when the navigation device is powered off, the corresponding information is recorded from a RAM onto a flash memory by overwriting.

As described above, the image transferring apparatuses 1 to 4 and the corresponding image transferring method transfer the binary image 30 of the memory device “A” into the memory device “B” such that areas included in the binary image 30 and having no valid data become free areas of the memory device “B” with respect to which physical addresses and logical addresses have not been associated. Therefore, as compared to the case of transferring the binary image 30 without correction, it is possible to increase the capacity of free areas, and it is possible to prolong the usable period of the memory device “B”.

Also, the image transferring apparatus 1 according to the embodiment and the corresponding image transferring method determine areas included in the binary image 30 and having no valid data, and perform transferring of the binary image 30, without writing the data of the areas determined as areas having no valid data, in the memory device “B”. In this way, even after the binary image 30 is generated, it is possible to transfer the binary image 30 such that the capacity of free areas of the memory device “B” increases.

Also, the image transferring apparatus 2 according to the embodiment and the corresponding image transferring method generate the image files 31 to 33 of the plurality of areas except for the areas included in the binary image 30 and having no valid data, and write the image files 31 to 33 of the plurality of areas in areas of the memory device “B” having corresponding addresses, thereby performing transferring of the binary image 30. In this way, the image writing device 50 can increase the capacity of free areas of the memory device “B” only by writing the image files 31 to 33 at the designation addresses.

Also, the image transferring apparatus 3 according to the embodiment and the corresponding image transferring method set the dummy files in the areas included in the binary image 30 and having no valid data, thereby generating the image file 34, and write the image file 34 including the dummy files, in the memory device “B”, and delete the dummy files from the memory device “B”, thereby performing transferring of the binary image 30. In this way, even after the image file 34 is written in the memory device “B”, it is easily increase the capacity of free areas of the memory device “B” only by performing the process of deleting the dummy files.

Also, the image transferring apparatus 4 according to the embodiment and the corresponding image transferring method write the binary image 37 in the memory device “B”, and then delete the data of the areas having no valid data, from the memory device “B” preserving the binary image 37, thereby performing transferring of the binary image 30. In this way, even after the image file 34 is written in the memory device “B”, it is possible to easily increase the capacity of free areas of the memory device “B” only by deleting the data of the areas having no valid data.

Also, each of the image generating devices 10, 40, 60, and 80 described above includes various circuits and a micro computer having various components such as a central processing unit (CPU), a read only memory (ROM), a random access memory (RAM), and an input/output port. The CPU of the micro computer reads out and executes programs stored in the ROM, thereby functioning as the individual units 11 to 13, 41 to 44, 61 to 65, or 81 to 85 described above.

Also, each of the image writing devices 20, 50, 70, and 90 described above includes various circuits and a micro computer having various components such as a CPU, a ROM, a RAM, and an input/output port. The CPU of the micro computer reads out and executes programs stored in the ROM, thereby functioning as the individual units 21 to 24, 51 to 53, 71 to 74, or 91 to 94 described above.

Although a case where each of the image transferring apparatuses 1 to 4 is divided into an image generating device and an image writing device has been described, the configurations of the image transferring apparatuses 1 to 4 are not limited to the above described configurations. For example, each image transferring apparatus may have a configuration in which an image generating device and an image writing device are integrally formed, or may have a configuration in which a part of an image generating device is included in an image writing device.

Also, although a case where the memory devices “A” and “B” described above have the same memory capacity has been described, eve in a case where the memory capacity of the memory device “B” is larger than the memory capacity of the memory device “A”, it is possible to increase the capacity of free areas as compared to the case of transferring the binary image 30 without correction.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A method of transferring a binary image into a memory device having a memory controller for performing conversion between physical addresses and logical addresses of storage areas,
wherein the binary image is transferred into the memory device such that areas included in the binary image and having no valid data become free areas in storage areas of the memory device, the free areas to which physical addresses and logical addresses are not associated.

2. The method according to claim 1,
wherein the areas included in the binary image and having no valid data are determined, and
wherein transferring of the binary image is performed, without writing the data of the areas determined as having no valid data, in the memory device.

3. The method according to claim 1, wherein transferring of the binary image is performed by generating image files of a plurality of areas of the binary image except for the areas having no valid data, and writing the image files of the plurality of areas in corresponding storage areas of the memory device.

4. The method according to claim 1, wherein transferring of the binary image is performed by setting deletable dummy files in the areas included in the binary image and having no valid data, and writing the binary image including the dummy files in the memory device, and deleting the dummy files from the memory device.

5. The method according to claim 1, wherein transferring of the binary image is performed by generating a deletion-area designation file specifying the areas having no valid data, and writing the binary image in the memory device, and deleting the data of the areas having no valid data from the memory device on the basis of the deletion-area designation file.

6. An apparatus for transferring a binary image into a memory device having a memory controller for performing conversion between physical addresses and logical addresses of storage areas, comprising:
a transferring unit configured to transfer the binary image into the memory device such that areas included in the binary image and having no valid data become free areas in storage areas of the memory device, the free areas to which physical addresses and logical addresses are not associated.

7. The apparatus according to claim 6, further comprising:
an acquiring unit configured to acquire the binary image;
a determining unit configured to determine the areas included in the binary image and having no valid data; and
a writing unit configured to write the binary image acquired by the acquiring unit, in the memory device while skipping the areas determined as having no valid data by the determining unit.

8. The apparatus according to claim 6, further comprising:
a determining unit configured to determine the areas included in the binary image and having no valid data;
a generating unit configured to generate image files of a plurality of areas except for the areas determined as having no valid data by the determining unit; and
a writing unit configured to write the image files of the plurality of areas generated by the generating unit, in corresponding storage areas of the memory device.

9. The apparatus according to claim 6, further comprising:
a generating unit configured to generate an image file by setting dummy files in the areas included in the binary image and having no valid data;
a writing unit configured to write the image file including the dummy files, in the memory device; and
a deleting unit configured to delete the dummy files from the memory device.

10. The apparatus according to claim 6, further comprising:
a determining unit configured to determine the areas included in the binary image and having no valid data;
a generating unit configured to generate a deletion-area designation file specifying the areas determined as having no valid data by the determining unit;
a writing unit configured to write the binary image in the memory device; and
a deleting unit configured to delete the data of the areas determined as having no valid data by the determining means, from the memory device preserving the binary image, on the basis of the deletion-area designation file.
